(19) United States
(12) Patent Application Publication
(10) Pub. No.: US 2023/0173312 A1
(43) Pub. Date: Jun. 8, 2023

(54) HARNESS ASSEMBLY WITH INDEPENDENTLY ADJUSTABLE PANELS

(71) Applicant: Benny Aaron Gregoire, Jr., St. Amant, LA (US)

(72) Inventor: Benny Aaron Gregoire, Jr., St. Amant, LA (US)

(21) Appl. No.: 18/102,318

(22) Filed: Jan. 27, 2023

Related U.S. Application Data
(60) Provisional application No. 63/283,425, filed on Nov. 27, 2021.
(60) Provisional application No. 63/435,716, filed on Dec. 28, 2022.

(51) Int. Cl. A62B 35/00

(52) U.S. Cl. CPC A62B 35/0012

(57) ABSTRACT

A harness assembly for use in saddle hunting or other activities in which a human body is suspended includes an upper panel and a lower panel. Upper panel loops are connected to respective lateral edges of the upper panel. Lower panel loops are connected to respective lateral edges of the lower panel. First and second yokes interconnect the upper panel and the lower panel via fastening elements that are slidable along the loops, thereby permitting independent movement of the upper and lower panels. Accordingly, the upper and lower panels may be moved independently of one another so that a user may position the panels to conform to the user's body in various body positions.

### CROSS-REFERENCE TO RELATED APPLICATIONS

This application claims the benefit of U.S. Provisional Patent Application No. 63/283,425, filed Nov. 27, 2021, which is hereby incorporated by reference in its entirety; this application also claims the benefit of U.S. Provisional Patent Application No. 63/435,716, filed Dec. 28, 2022, and which is hereby incorporated by reference in its entirety.

### TECHNICAL FIELD

This disclosure relates to harnesses for supporting a human in a suspended position.

### BACKGROUND

Hunters often hunt from an elevated position above the ground, which reduces the likelihood that they will be detected by game animals while also providing the hunter with an enhanced field of view for spotting and shooting game animals. Some hunters may use a wooden or steel structure to support a platform above the ground, thereby providing an elevated surface for the hunter. However, the support structure is problematic because it is expensive and heavy, and it must be transported to the hunting location (which may be remote). The size and complexity of the support structure makes it difficult to move, thereby reducing a hunter's options. Other hunters may employ stands mounted to a tree with a seat.

In lieu of a heavy tree stand, “saddle hunting” involves the use of a harness worn by a hunter to suspend the hunter above the ground via a flexible tether mounted to a tree. Saddle hunting eliminates the need for heavy, bulky equipment. Furthermore, saddle hunting provides significantly greater movement compared to a traditional tree stand because the hunter is free to move in almost every direction, whereas a stationary seat limits a hunter's movements.

However, with the hunter being suspended by the harness, it is important that the harness be comfortable and secure to ensure the ability to hunt for extended periods of time and to avoid injury.

### SUMMARY

A harness assembly for use during saddle hunting is provided. The harness assembly includes a flexible upper panel and a flexible lower panel. First and second upper panel loops are attached to the upper panel. First and second lower panel loops are attached to the lower panel. A yoking system interconnects the upper panel and the lower panel in a manner that permits the selective, independent movement of the upper and lower panels relative to one another, thereby changing the shape and contour of the saddle/harness, which allows for the user's body type to be accommodated, and thus increase comfort while in use.

A corresponding method of using the harness assembly is also provided.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, rear view of a harness assembly having a upper panel and a lower panel in accordance with the claimed invention;

FIG. 2 is a schematic, side view of the harness assembly mounted to a tree with a tether and with the lower panel in a first position relative to the upper panel;

FIG. 3 is a schematic, side view of the harness assembly;

FIG. 4 is a schematic, side view of the harness assembly with the lower panel in a second position relative to the upper panel; and

FIG. 5 is a schematic, rear view of the harness assembly.

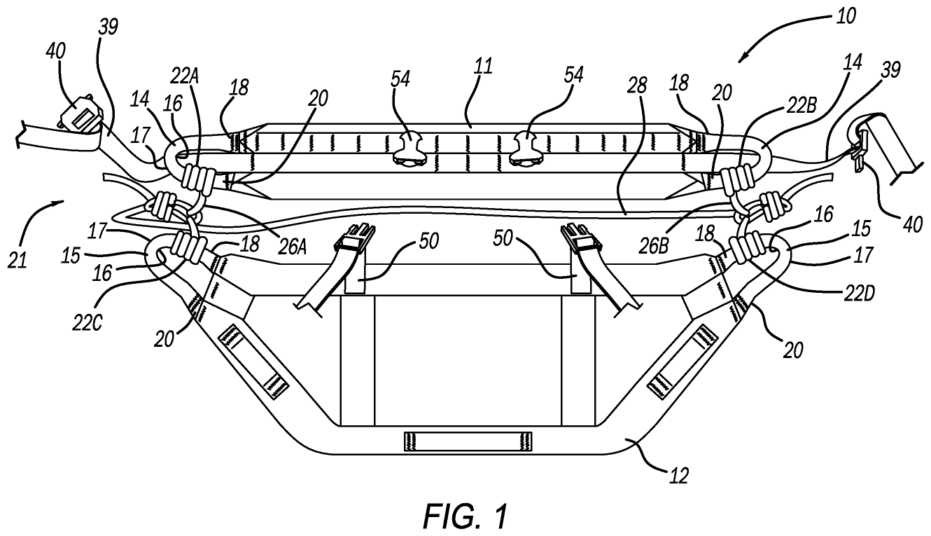

### DETAILED DESCRIPTION

Referring to the Figures, wherein like reference numbers refer to like components throughout, a harness assembly 10 for use in saddle hunting or other activities is schematically depicted. The harness assembly 10 includes an upper panel 11 and a lower panel 12. Each of the panels 11, 12 is comprised of flexible materials such as fabric, mesh, etc. Those skilled in the art will recognize suitable materials that have adequate flexibility and strength to both bear the weight of a human user and to be adequately comfortable.

The assembly 10 also includes first and second upper panel loops 14 and first and second lower panel loops 15. Each of the upper panel loops 114 is mounted to a respective lateral edge of the upper panel 11, such as by sewing. Each of the lower panel loops 15 is mounted to a respective lateral edge of the lower panel 12, such as by sewing. In the embodiment depicted, the loops 14, 15 are flexible material, but any suitable material may be employed within the scope of the claimed invention.

Each of the loops 14, 15 is generally arcuate or C-shaped in the embodiment depicted. More specifically, each loop 14, 15 is characterized by a curvature and defines a respective concave inner surface 16 and a convex outer surface 17. The loops 14, 15 in the embodiment depicted are formed by members having a respective first end 18 and second end 20, each end 18, 20 mounted to one of the panels 11, 12.

A yoking system 21 interconnects the upper and lower panels 11, 12. In the embodiment depicted, the yoking system 21 includes includes a first fastening element 22A, a second fastening element 22B, a third fastening element 22C, and a fourth fastening element 22D. The first fastening element 22A is connected to the first upper panel loop 14 such that the first fastening element 22A is selectively slidable along the first upper panel loop 14. The second fastening element 22B is connected to the second upper panel loop 14 such that the second fastening element 22B is selectively slidable along the second upper panel loop 14. The third fastening element 22C is connected to the first lower panel loop 15 such that the third fastening element 22C is selectively slidable along the first lower panel loop 15. The fourth fastening element 22D is connected to the second lower panel loop 15 such that the fourth fastening element 22D is selectively slidable along the second lower panel loop 15.

The yoking system 21 also includes a first yoke 26A and a second yoke 26B. The first yoke 26A interconnects the first fastening element 22A and the third fastening element 22C. The second yoke 26B interconnects the second fastening element 22B and the fourth fastening element 22D.

In the embodiment depicted, the fastening elements 22A, 22B, 22C, 22D are prusik loops of rope that are wrapped around their respective loop 14, 15. When the prusik loops of fastening elements 22A-22D are tightened, the friction between each fastening element 22A-22D and its respective loop 14, 15 is sufficient to prevent relative motion (i.e., sliding) between the fastening element 22A-22D and their respective loops 14, 15. The friction may be lessened to permit relative motion (i.e., sliding) between the fastening elements 22A-22D by loosening the prusik loops.

Although fastening elements 22A-22D are prusik loops in the embodiment depicted, it should be noted that other fastening element configurations that are configured to connect to, and selectively slide along, the loops 14, 15 may be employed within the scope of the claimed invention. For example, and within the scope of the claimed invention, fastening elements 22A-22D may include annular members through which the loops 14, 15 extend; mechanical mechanisms attached to the annular members may be configured to compress the loops 14, 15 when engaged to lock the annular members relative to the loops 14, 15, and when disengaged permit the annular members to slide along the loops 14, 15.

The first and second yokes 26A, 26B are flexible members such as, but not limited to, Amsteel rope, climbing cordage, or other ropes capable of bearing a load. A harness bridge 28 is a rope that connects on each side of the harness assembly 10, left hip region to right hip region. In one embodiment, it is between 20 inches and 30 inches in length with tied or spliced ends. These ends attach to the middle of the independent panel adjustment system, e.g., to a respective one of the yokes 26A, 26B. The bridge 28 disperses and supports the load carried by the harness assembly 10.

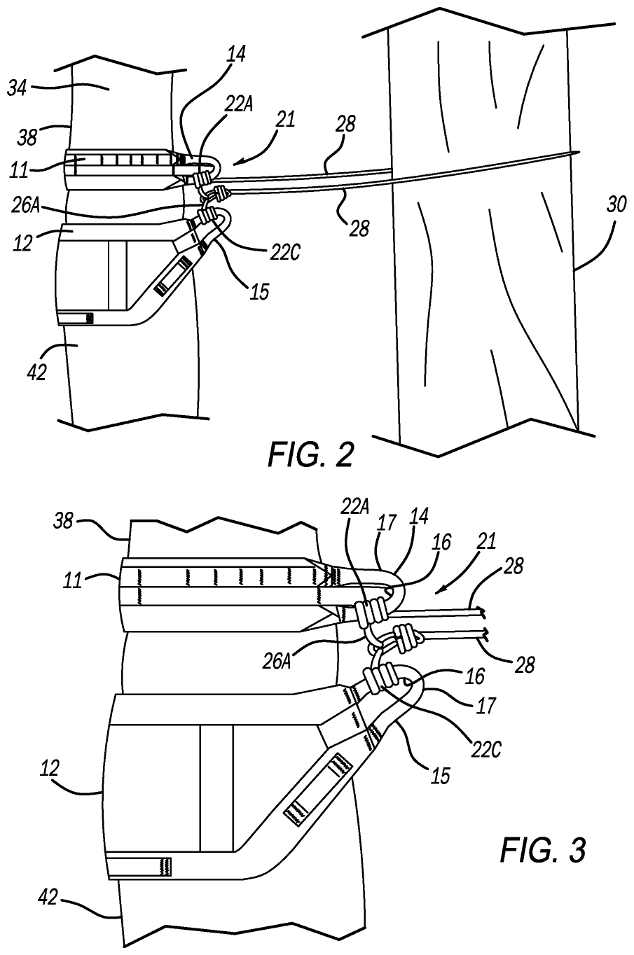

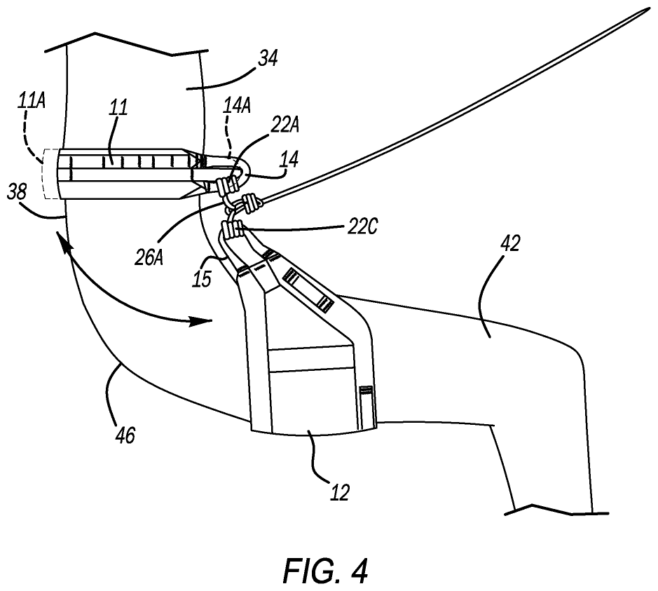

Referring specifically to FIGS. 2 and 3, the harness assembly 10 is mountable to a tree 30 via the harness bridge 28. The upper panel 11 is configured to support the upper portion of a hunter's body 34, and more specifically, the hunter's back 38. The lower panel 12 is configured to support the hunter's legs 42 and/or buttocks (shown at 46 in FIG. 4). In FIG. 2, the hunter is depicted in a standing position, and the upper and lower panels 11, 12 are generally vertically oriented.

As shown in FIG. 4, the hunter may rotate his or her legs 42 at the hip such that the thighs of the legs 42 are more horizontal than in FIG. 2. The lower panel 12 as shown in FIG. 4 is rotated relative to the yokes 26A, 26B and the upper panel 11 from its position in FIGS. 2 and 3 to accommodate the change in the hunter's leg 42 position. To move the lower panel 12 independently of the upper panel 11, the prusik loops of the fasteners 22C, 22D are loosened such that the lower panel loops 15 are slidable relative to the fasteners 22C, 22D from the position shown in FIGS. 2 and 3 to the position shown in FIG. 4 in which the lower panel 12 is rotated approximately 90 degrees from the position shown in FIGS. 2 and 3. Once the lower panel 12 is in a desired position relative to the upper panel 11 and the user's legs 42 or buttocks 46, the user will tighten the prusik loops of the fasteners 22C, 22D to lock the fasteners 22C, 22D relative to the lower panel loops 15.

Notably, the upper panel 11 is likewise independently movable relative to the yoking system and the lower panel 12 by loosening the prusik loops of fastening elements 22A, 22B to permit the sliding of the upper panel loops 14 relative to the fastener elements 22A, 22B, which in turn permits the independent movement of the upper panel 11 relative to the lower panel 12. Thus, for example, if the hunter wants to move the upper panel 11 fore or aft, without altering the position of the lower panel 12, the hunter simply slides the loops 14 relative to fasteners 22A, 22B so that the loops are in the position shown in phantom at 14A and the upper panel is in the position shown in phantom at 11A. As used herein, one panel moves independently of another panel if the movement of one panel does not require or cause movement of the other panel.

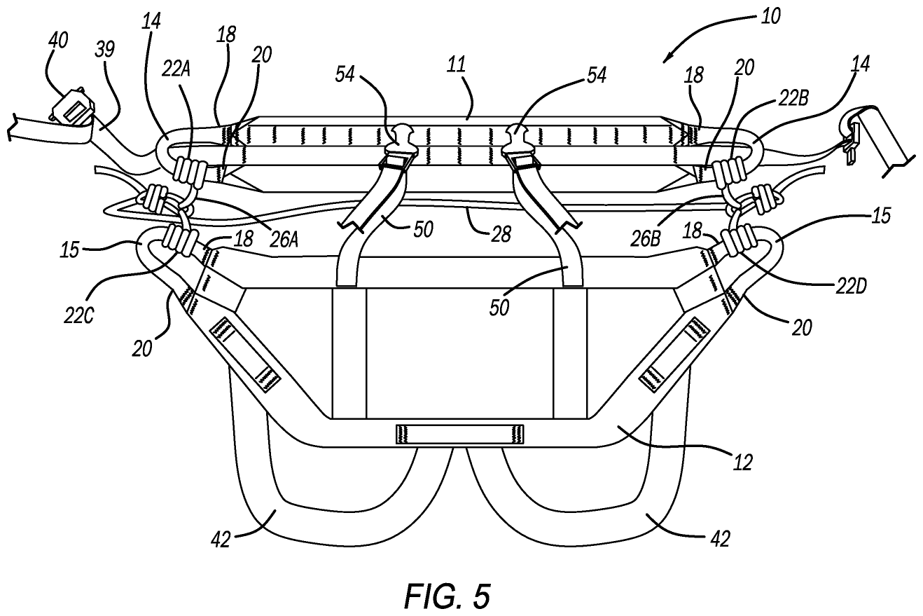

Referring specifically to FIGS. 5 and 6, the upper panel 11 and lower panel 12 may comprise one or more of seat belt webbing, tubular, webbing, and meshes. The upper panel 11 is connected to a waist belt 39 and waist buckle 40, the function of which will be understood by those skilled in the art. Leg straps 42 may be attached to the lower panel 12 for use as understood by those skilled in the art. Straps 50 may be attached to the lower panel 12 and matable with buckles 54 on the upper panel 11. The lengths of straps 50 are adjustable so that, once the assembly 10 is in the shape and configuration desired, the upper panel 11 and lower panel 12 can be interconnected via the straps 50 and buckles 54 as shown in FIG. 5.

While the best modes for carrying out the disclosure have been described in detail, those familiar with the art to which this disclosure relates will recognize various alternative designs and embodiments for practicing the disclosure within the scope of the appended claims.

1. A harness assembly comprising:
an upper panel and a lower panel;
said upper panel having first and second upper panel loops mounted thereto;
said lower panel having first and second lower panel loops mounted thereto;
a first fastening element operatively connected to the first upper panel loop such that the first fastening element is selectively slidable along the first upper panel loop;
a second fastening element operatively connected to the second upper panel loop such that the second fastening element is selectively slidable along the second upper panel loop;
a third fastening element operatively connected to the first lower panel loop such that the third fastening element is selectively slidable along the first lower panel loop;
a fourth fastening element operatively connected to the second lower panel loop such that the fourth fastening element is selectively slidable along the second lower panel loop;
a first yoke member interconnecting the first fastening element and the third fastening element;
a second yoke member interconnecting the second fastening element and the fourth fastening element.

2. The harness assembly of claim 1, further comprising a bridge having a first end operatively connected to the first yoke member and a second end operatively connected to the second yoke member.

3. The harness assembly of claim 1, wherein each of said first, second, third, and fourth fastening elements are configured such that friction between between each of the fastening elements and a respective one of the upper and lower panel loops is selectively variable.

4. The harness assembly of claim 3, wherein said first, second, third, and fourth fastening members are prusik loops.

5. The harness assembly of claim 4, wherein said prusik loops are configured as prusik knots; and
wherein the friction between each of said first, second, third, and fourth fastening elements and the upper and lower panel loops is variable by tightening or loosening said prusik knots.

6. A method comprising:
operatively connecting the harness assembly of claim 1 to a tree; and
moving the lower panel independently of the upper panel by sliding the first and second lower panel loops relative to the third and fourth fastening elements.

7. The method of claim 6, wherein the upper panel contacts a back during said moving the lower panel; and
wherein said lower panel contacts legs or buttocks after said moving the lower panel.

8. The method of claim 6, further comprising moving the upper panel independently of the lower panel by sliding the first and second upper panel loops relative to the first and second fastening elements.

9. The method of claim 6, wherein said first, second, third, and fourth fastening elements are prusik loops formed as prusik knots.
